(19) United States
(12) Patent Application Publication
(10) Pub. No.: US 2025/0202208 A1
(43) Pub. Date: Jun. 19, 2025

(54) WIRE HARNESS

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventor: Hirohito KINOSHITA, Yokkaichi-shi (JP)

(73) Assignees: AUTONETWORKS TECHNOLOGIES, LTD., Yokkaichi-shi, Mie (JP); SUMITOMO WIRING SYSTEMS,LTD., Yokkaichi-shi, Mie (JP); SUMITOMO ELECTRIC INDUSTRIES, LTD., Osaka-shi,Osaka (JP)

(21) Appl. No.: 18/849,259

(22) PCT Filed: Mar. 13, 2023
(86) PCT No.: PCT/JP2023/009634

§ 371 Date: Sep. 20, 2024

(30) Foreign Application Priority Data
Apr. 1, 2022 (JP) 2022-061536

(51) Int. Cl. H02G 3/04; H01B 7/00

(52) U.S. Cl. CPC H02G 3/0406; H01B 7/0045

(57) ABSTRACT

A wire harness including: an elastically deformable harness body that includes a bend that is elastically bent and a pair of low-curvature sides having a smaller curvature than the bend; and a holding body that holds the bend in a bent state by bringing only the pair of low-curvature sides of the harness body into contact with the holding body.

### BACKGROUND

The present disclosure relates to a wire harness.

JP 2012-022803A discloses a wire harness including a wire bundle and a skeletal member that is arranged longitudinally on a wire bundle. The skeletal member has a bending portion, and the wire bundle can be routed along a predetermined bending path by binding the wire bundle and the skeletal member together using a binding means.

### SUMMARY

When a wire bundle is bent, a portion of the wire bundle located on the outer side of the bent part of the wire bundle is subjected to a tensile force. If a fastening force from a binding means is directly applied to the portion of the wire bundle that is located on the outer side of the bent part and is receiving the tensile force, a load on the bent part increases.

An exemplary aspect of the disclosure is to be able to hold a bent part in a bent shape without increasing a load on the bent part.

A wire harness according to the present disclosure includes: an elastically deformable harness body that includes a bend that is elastically bent and a pair of low-curvature sides having a smaller curvature than the bend; and a holding body that holds the bend in a bent state by bringing only the pair of low-curvature sides of the harness body into contact with the holding body.

According to the present disclosure, it is possible to hold the bend in a bent shape without increasing a load on the bent part.

### BRIEF DESCRIPTION OF THE DRAWINGS

FIG. 1 is a perspective view of a wire harness according to Embodiment 1.

FIG. 2 is a rear view of a harness body in a cut state.

FIG. 3 is a cross-sectional view taken along line A-A in FIG. 2.

FIG. 4 is a cross-sectional view taken along line B-B in FIG. 2.

FIG. 5 is a cross-sectional view equivalent to the cross-sectional view taken along line A-A, showing a state realized after the harness body is attached to a holding member and before a positioning member is attached to the holding member.

FIG. 6 is a perspective view of the holding member.

FIG. 7 is a perspective view of the positioning member.

### DETAILED DESCRIPTION OF EMBODIMENTS

### Description of Embodiments of the Present Disclosure

First, embodiments of the present disclosure will be listed and described.

A wire harness according to the present disclosure includes:
(1) an elastically deformable harness body including a bent part that is elastically bent and a pair of low-curvature parts having a smaller curvature than the bent part; and a holding member that holds the bent part in a bent state by bringing only the pair of low-curvature parts of the harness body into contact with the holding member. According to the present disclosure, since the holding member does not come into contact with the bent part, the load on the bent part is not increased by the contact with the holding member. Therefore, it is possible to hold the bent part in a bent shape without increasing a load on the bent part.
(2) It is preferable that the holding member is made of a material having a higher hardness than outer peripheral portions of the low-curvature parts. With this configuration, the frictional resistance caused by elastic deformation of the outer peripheral portions of the low-curvature parts prevents positional misalignment between the low-curvature parts and the holding member. The holding member is made of a material having a higher hardness than the low-curvature parts, and thus is relatively hard to deform. Thus, it is possible to reliably prevent expansion and deformation of the pair of low-curvature parts.
(3) It is preferable that the holding member has a ring shape that is continuous around the entire perimeter, and the pair of low-curvature parts are inserted into the holding member. Since the holding member has a ring shape that is continuous around the entire perimeter, even when the pair of low-curvature parts are about to expand due to elastic restoring force of the bent part, expansion and displacement of the pair of low-curvature parts can be prevented. This allows the bent part to be maintained at an expected curvature.
(4) In (3), it is preferable that the wire harness includes a positioning member that is disposed on the inner side of the holding member and sandwiches the low-curvature parts together with the holding member. With this configuration, it is possible to prevent the low-curvature parts from being displaced relative to the holding member in an axial direction.
(5) In (4), it is preferable that the positioning member is attached to the holding member so that the positioning member is press-fitted between the pair of low-curvature parts. With this configuration, positional misalignment of the low-curvature parts with respect to the holding member can be suppressed by the frictional resistance between the low-curvature parts and the holding member and the frictional resistance between the low-curvature parts and the positioning member.
(6) In (4) or (5), it is preferable that both the holding member and the positioning member are made of a material having a higher hardness than outer peripheral portions of the low-curvature parts. With this configuration, the low-curvature parts can be reliably sandwiched between the holding member and the positioning member, thus preventing positional misalignment of the low-curvature parts.
(7) In (6), it is preferable that, when a direction in which the low-curvature parts are sandwiched between the holding member and the positioning member is defined as a width direction, the maximum dimension of the positioning member in the width direction is larger than a dimension obtained by subtracting a sum of the maximum outer dimensions of the low-curvature parts in the width direction from the maximum dimension of the holding member between inner surfaces of the holding member in the width direction. With this configuration, the low-curvature parts are compressed and deformed between the holding member and the positioning member, and thus positional misalignment of the low-curvature parts is unlikely to occur.
(8) In (6) or (7), it is preferable that edges of an outer peripheral surface of the positioning member, the edges coming into sliding contact with the low-curvature parts in a process of attaching the positioning member to the holding member, are provided with interference mitigation portions each constituted by a curved surface or a tapered surface. When attaching the positioning member to the holding member while inserting the positioning member between the pair of low-curvature parts, the interference mitigation portions constituted by the curved surfaces or the tapered surfaces come into sliding contact with the low-curvature parts. This can prevent the low-curvature parts from being scratched by the positioning member.
(9) In (4) to (8), it is preferable that the positioning member has a through space extending in the same direction as a direction in which the low-curvature parts are inserted into the holding member. With this configuration, it is possible to reduce the weight of the positioning member and a material cost.
(10) In (4) to (9), it is preferable that one of the holding member and the positioning member has an elastic locking piece that is elastically displaceable, and the other of the holding member and the positioning member has a locking hole in which the elastic locking piece is locked. By locking the elastic locking piece in the locking hole, the positioning member can be kept attached to the holding member.
(11) In (10), it is preferable that the positioning member has a through space extending in the same direction as a direction in which the low-curvature parts are inserted into the holding member, the elastic locking piece is formed on the positioning member, and the elastic locking piece is elastically deformed to enter the through space in a process of attaching the positioning member to the holding member. Because the through space functions as a warp allowing space for the elastic locking piece, the shape of the positioning member can be simplified compared to a case where the warp allowing space for the elastic locking piece is formed separately from the through space.
(12) In (11), it is preferable that the positioning member includes a pair of thin walls on each of which the elastic locking piece is formed, and a pair of thick walls that are thicker than the thin walls and press the pair of low-curvature parts and sandwich the pair of low-curvature parts together with the holding member. The elastic locking pieces formed on the thin walls are likely to be elastically displaced, it is possible to reduce the frictional resistance between the elastic locking pieces and the holding member and improve assembly workability in the process of attaching the positioning member to the holding member. Because the thick walls, which are thicker than the thin walls, are less likely to be elastically deformed even when subjected to a reaction force from the low-curvature parts, the low-curvature parts can be reliably positioned between the holding member and the thick walls.
(13) In (12), it is preferable that the holding member includes a locking wall having the locking hole, and the locking wall has a larger thickness than the thin walls. Each locking wall is relatively thick and has a deep locking hole, and thus it is possible to ensure a large locking allowance between a locking hole and an elastic locking piece in the thickness direction of the locking wall.
(14) In (10) to (13), it is preferable that a wall of the holding member and a wall of the positioning member are overlapped in a direction intersecting a direction in which the low-curvature parts are sandwiched therebetween to form a stacked wall, and the stacked wall is provided with both the elastic locking piece and the locking hole. The stacked wall is constituted by the walls overlapping each other in the direction intersecting the direction in which the low-curvature parts are sandwiched, and thus the stacked wall does not face the low-curvature parts. Because the elastic locking pieces and the locking holes are disposed at positions where they do not face the low-curvature parts, interference between the low-curvature parts and the elastic locking pieces can be prevented.
(15) In (14), it is preferable that the stacked wall is provided as two stacked walls, and the two stacked walls are disposed at two positions spaced apart from each other in a direction orthogonal to a direction in which the pair of low-curvature parts are arranged, and the two stacked walls are each provided with the elastic locking piece and the locking hole. With this configuration, the elastic locking pieces are locked in the locking holes at two positions spaced apart from each other, and thus the positioning member can be reliably held by the holding member.
(16) In (14) or (15), it is preferable that the locking hole is provided as a pair of locking holes, and the pair of locking holes are arranged obliquely with respect to a direction in which the low-curvature parts are inserted into the holding member. With this configuration, a longer separation distance between the locking holes can be ensured in the limited space defined by the stacked walls, compared to a case where the pair of locking holes are arranged parallel the direction in which the low-curvature parts are inserted into the holding member (insertion direction of the low-curvature parts), and a case where the pair of locking holes are arranged in a direction orthogonal to the insertion direction of the low-curvature parts. This makes it possible to suppress relative rotation between a wall of the holding member that constitutes the stacked wall and a wall of the positioning member that constitutes the stacked wall when a rotational force, which is centered on a virtual axis parallel to the overlapping direction of the stacked wall, is applied to the wall of the holding member and the wall of the positioning member.
(17) In (10) to (16), it is preferable that the elastic locking piece is provided as a plurality of elastic locking pieces including a long elastic locking piece and a short elastic locking piece, and the long elastic locking piece and the short elastic locking piece are arranged in parallel to each other. With this configuration, by arranging two elastic locking pieces having different lengths side-by-side, it is possible to reduce assembly resistance when attaching the positioning member to the holding member and realize a function to prevent the positioning member from coming loose.

### DETAILS OF EMBODIMENTS OF THE PRESENT DISCLOSURE

### Embodiment 1

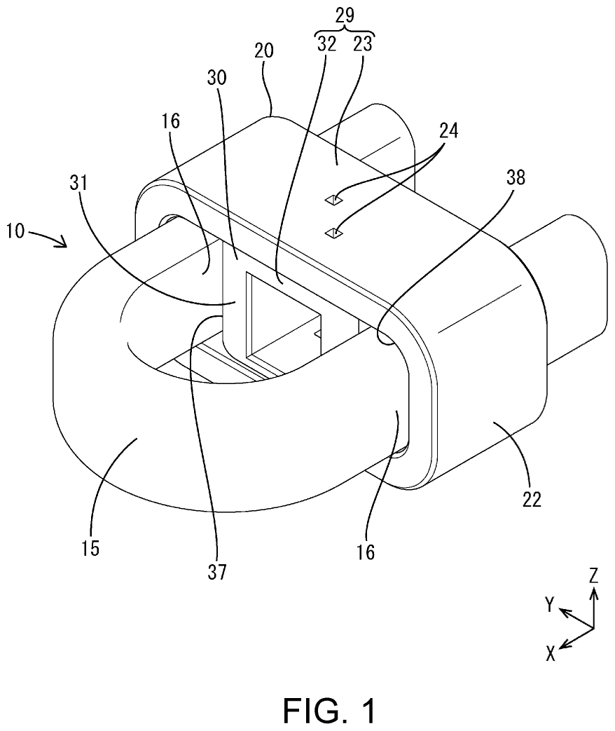

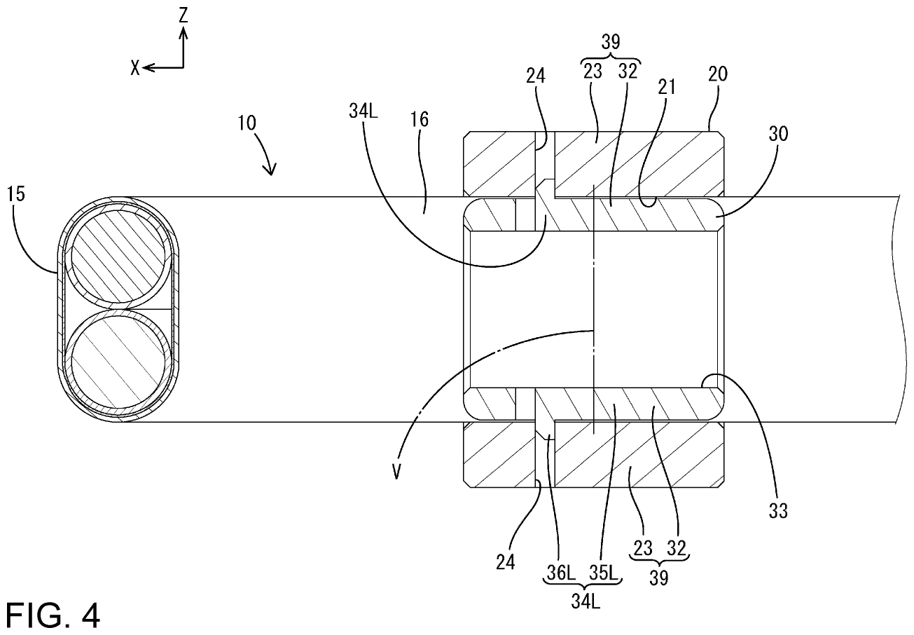

A wire harness according to Embodiment 1 of the present disclosure will be described with reference to FIGS. 1 to 7. The present disclosure is not limited to these examples, and is indicated by the claims, and is intended to include all modifications within the meaning and scope equivalent to the claims. In Embodiment 1, with regard to a front-rear direction, a positive direction on the X-axis in FIGS. 1, and 3 to 7 is defined as a forward direction. With regard to a left-right direction, a positive direction on the Y-axis in FIGS. 1 to 3 and 5 to 7 is defined as a right direction. The left-right direction and the width direction are used synonymously. With regard to an up-down direction, a positive direction on the Z-axis in FIGS. 1, 2, 4, 6, 7 is defined as an upper direction. The up-down direction and the height direction are used synonymously.

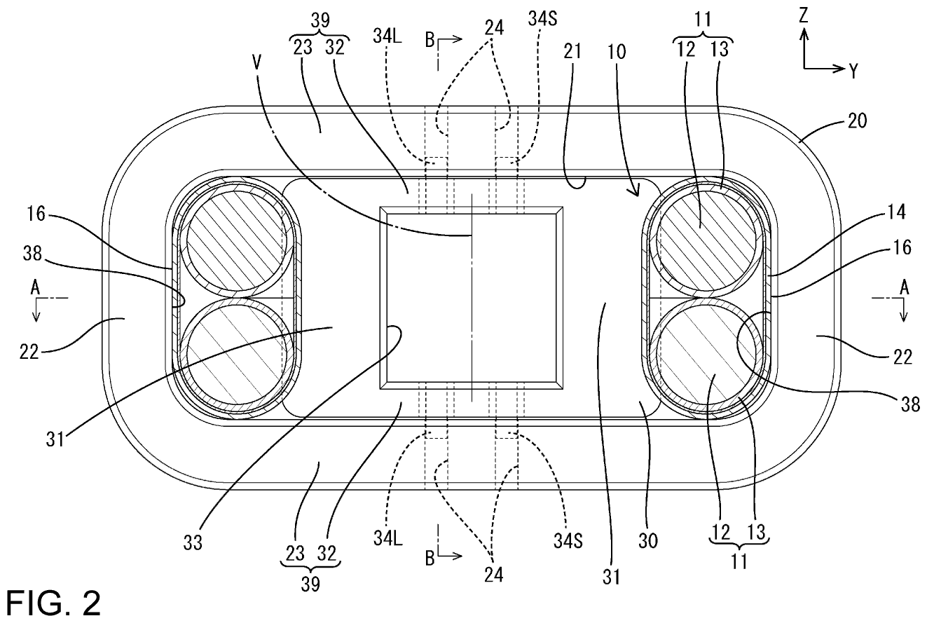

As shown in FIG. 1, the wire harness according to Embodiment 1 is formed by assembling one harness body 10, one holding member 20 (holding body), and one positioning member 30 (positioning body). As shown in FIG. 2, the harness body 10 is a member in which a plurality (two in Embodiment 1) of parallel covered wires 11 are surrounded by a single oval outer cover body 14. Each covered wire 11 is a cable having a circular cross section in which a core wire 12 is surrounded by an insulating sheath 13. The outer cover body 14 is constituted by a sheath, a corrugated tube, a rubber tube, adhesive tape, a tubular protector, or a braided wire, in which the two covered wires 11 are embedded, and the like. The harness body 10 is arranged such that the two covered wires 11 are aligned vertically.

As shown in FIGS. 1, 3, and 5, in a plan view of the wire harness seen from above, the harness body 10 is arranged along a curved path folded back in a U-shape. The part of the harness body 10 that is curved to be folded back is defined as a bent part 15 (bend). Parts of the harness body 10 that extend from both ends of the bent part 15 in the axial direction are defined as a pair of low-curvature parts 16 (low-curvature sides). Each low-curvature part 16 is a part whose curvature is smaller than that of the bent part 15. The low-curvature part 16 may extend linearly or be a slightly curved part. The low-curvature part 16 of Embodiment 1 is a part that extends linearly and has a curvature of 0 (zero). The holding member 20 and the positioning member 30 come into contact with only the pair of low-curvature parts 16, thus holding the harness body 10 in a predetermined shape and keeping the bent part 15 curved at a predetermined curvature.

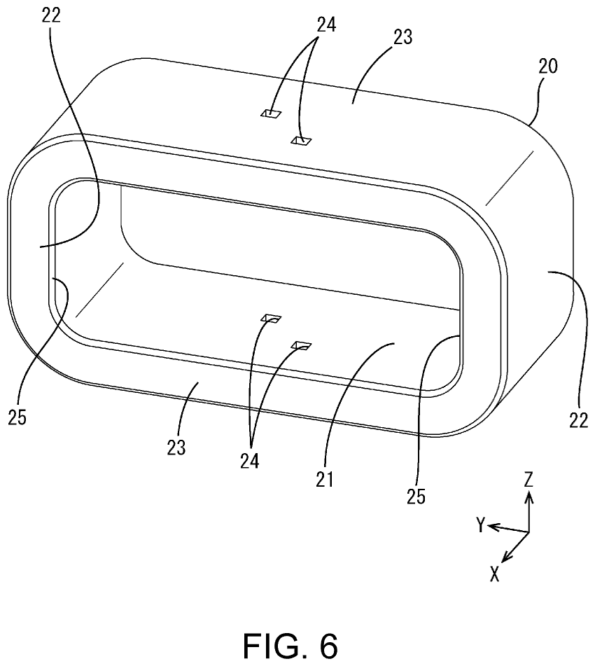

The holding member 20 is a single part made of a synthetic resin material having higher rigidity than the outer peripheral portion of the harness body 10. As shown in FIG. 2, in a front view of the holding member 20 seen from front, the holding member 20 has a rectangular frame shape whose width is larger than its height. An internal space of the holding member 20 is an accommodation space 21 extending through the holding member 20 in the front-rear direction. As shown in FIG. 6, the holding member 20 includes a pair of left and right pressure-receiving walls 22 whose wall thickness direction extends in the left-right direction, and a pair of upper and lower locking walls 23 whose wall thickness direction extends in the up-down direction. The thickness of the pressure-receiving walls 22 and the thickness of the locking walls 23 are of the same dimension.

The pair of upper and lower locking walls 23 are each provided with a pair of locking holes 24. The locking holes 24 extend through the locking walls 23 in the up-down direction. Each pair of locking holes 24 are arranged in a positional relationship such that the locking holes 24 are spaced apart from each other in an oblique direction with respect to both the front-rear direction and the left-right direction in a plan view of the holding member 20 seen from above. Tapered surfaces 25 are formed on inner edges of the pressure-receiving walls 22, out of opening edges of the accommodation space 21 on both front and rear surfaces of the holding member 20.

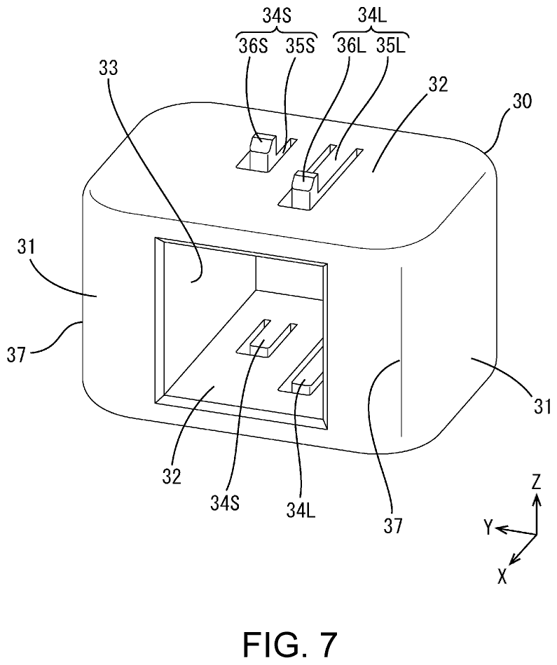

The positioning member 30 is a single part made of a synthetic resin material having higher rigidity than the outer peripheral portion of the harness body 10. The shape of the positioning member 30 in a front view is a rectangular shape whose width is larger than its height. As shown in FIG. 7, the positioning member 30 includes a pair of left and right thick walls 31 whose wall thickness direction extends in the left-right direction, and a pair of upper and lower thin walls 32 whose wall thickness direction extends in the up-down direction. The thick walls 31 are thicker than the thin walls 32, and are thicker than the pressure-receiving walls 22 and the locking walls 23. The thin walls 32 are thinner than the pressure-receiving walls 22 and the locking walls 23. The holding member 20 has a through space 33 surrounded by the pair of thick walls 31 and the pair of thin walls 32. The through space 33 is open to both the front and rear surfaces of the holding member 20.

The pair of upper and lower thin walls 32 are each provided with a long elastic locking piece 34L and a short elastic locking piece 34S. The long elastic locking piece 34L includes a long arm portion 35L extending in a cantilever shape in the front-rear direction, and a long side locking protrusion 36L protruding from an extending end of the long arm portion 35L to the outer surface side of the thin wall 32. The short elastic locking piece 34S includes a short arm portion 35S extending in a cantilever shape in the front-rear direction, and a short side locking protrusion 36S protruding from an extending end of the thin arm portion 35S to the outer surface side of the thin wall 32. The elastic locking pieces 34L and 34S are elastically deformable in a direction (up-down direction) in which these pieces enter the through space 33, with base end portions of the elastic locking pieces 34L and 34S serving as fulcrums.

In one thin wall 32, the long elastic locking piece 34L and the short elastic locking piece 34S are arranged side-by-side in the left-right direction. The base end portion of the long arm portion 35L and the base end portion of the short arm portion 35S are arranged at the same positions in the front-rear direction. Similarly to the locking holes 24, the long side locking protrusion 36L and the short side locking protrusion 36S are arranged in a positional relationship such that the locking protrusions 36L and 36S are spaced apart from each other in an oblique direction with respect to both the front-rear direction and the left-right direction.

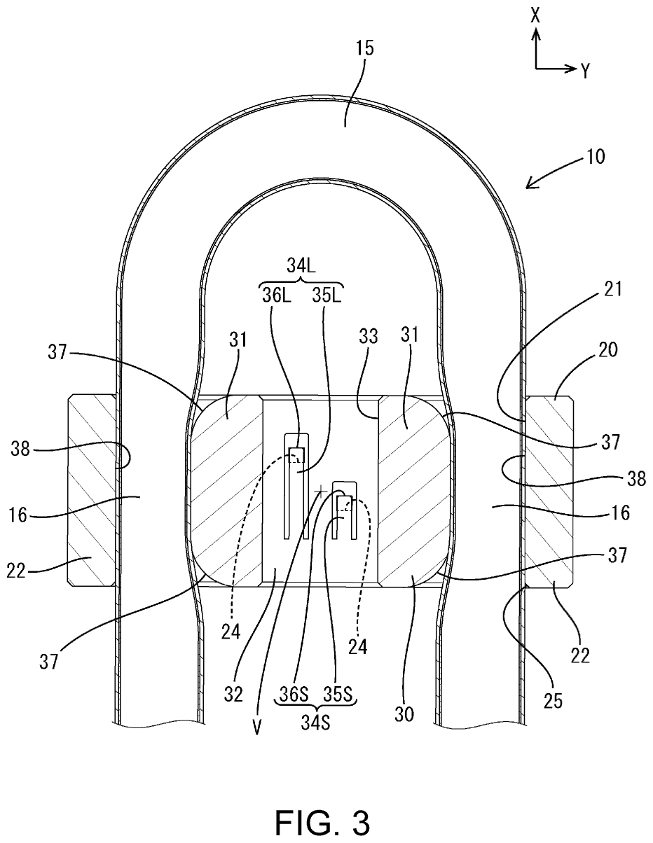

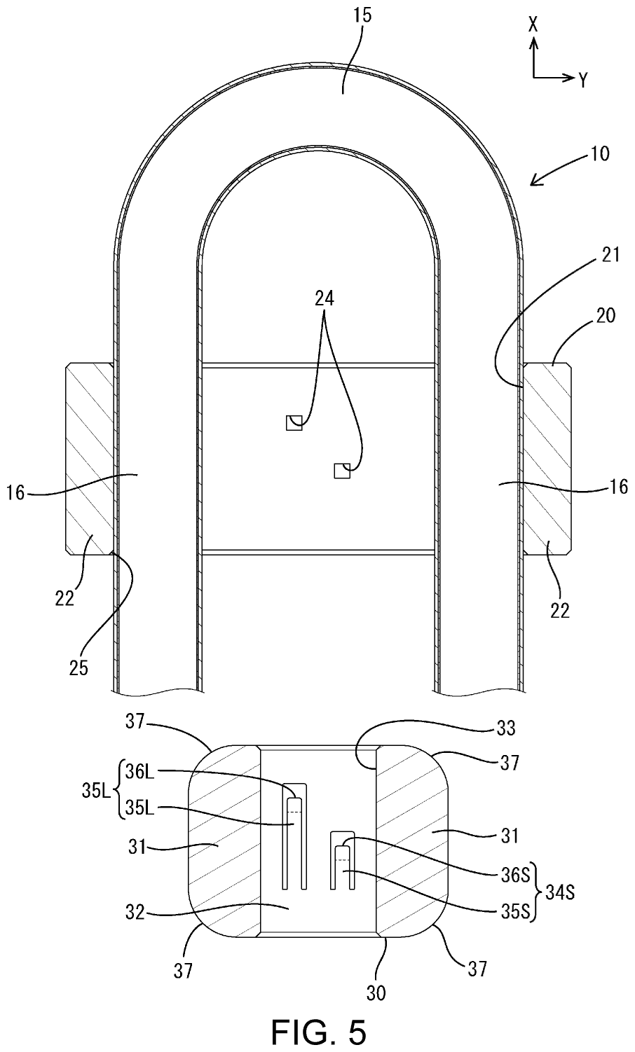

As shown in FIGS. 3 and 5, interference mitigation portions 37, each constituted by a curved surface, are formed at outer edges of the thick wall 31, out of the outer peripheral edges of the front and rear surfaces of the positioning member 30. In a plan view, the radius of the interference mitigation portions 37 is set to a dimension larger than the front-rear and left-right dimensions of the tapered surfaces 25 of the pressure-receiving wall 22.

The height of the positioning member 30 is equal to or slightly smaller than the height of the accommodation space 21. The width of the positioning member 30 is smaller than the width of the accommodation space 21. A difference between the width of the accommodation space 21 and the width of the positioning member 30 is set to a value smaller than twice the width of the harness body 10.

Next, a procedure for assembling the wire harness according to Embodiment 1 will be described. As shown in FIG. 5, the bent part 15 is formed by elastically deforming the harness body 10, and the bent part 15 is passed through the accommodation space 21 from the rear of the holding member 20, thus realizing a state in which the pair of low-curvature parts 16 are inserted into the accommodation space 21. The pair of low-curvature parts 16 are elastically pressed against the inner surfaces of the pair of pressure-receiving walls 22 by the elastic restoring force of the bent part 15. The pair of low-curvature parts 16 are temporarily kept in the state of being inserted into the accommodation space 21 by friction against the inner surfaces of the pressure-receiving walls 22.

Thereafter, the positioning member 30 is inserted between the pair of low-curvature parts 16 from the rear of the holding member 20 and thus attached into the accommodation space 21. During this process, the outer surfaces of the pair of thick walls 31 come into sliding contact with the pair of low-curvature parts 16. However, since the front interference mitigation portions 37 of the positioning member 30 obliquely come into sliding contact with the low-curvature parts 16, the positioning member 30 does not latch onto the low-curvature parts 16.

When a front end portion of the positioning member 30 starts to enter the accommodation space 21, the pair of low-curvature parts 16 are elastically deformed to be squashed in the left-right direction between the pressure-receiving walls 22 and the thick walls 31.

In the process in which the positioning member 30 enters the accommodation space 21, first, the long elastic locking piece 34L is elastically deformed to enter the through space 33 due to interference between the long side locking protrusion 36L and the locking wall 23. After the long elastic locking piece 34L starts to be elastically deformed, the short elastic locking piece 34S is elastically deformed to enter the through space 33 due to interference between the short side locking protrusion 36S and the locking wall 23. When the positioning member 30 reaches a predetermined assembly position at which the positioning member 30 is attached to the holding member 20, the long side locking protrusion 36L is locked to the locking hole 24 due to elastic return of the long elastic locking piece 34L, and at the same time, the short side locking protrusion 36S is locked to the locking hole 24 due to elastic return of the short elastic locking piece 34S.

In a state in which the positioning member 30 is attached to the holding member 20, as shown in FIGS. 2 and 3, a pair of left and right harness insertion spaces 38 are formed by being surrounded by the left and right end portions of the upper and lower locking walls 23, the pressure-receiving walls 22, and the thick walls 31. Only the pair of low-curvature parts 16 of the harness body 10 are respectively inserted into the pair of harness insertion spaces 38. The bent part 15 is not present in the harness insertion spaces 38 and is not in contact with any of the pressure-receiving walls 22, the thick walls 31, and the locking walls 23.

As shown in FIGS. 1, 2, and 4, in the state in which the positioning member 30 is attached to the holding member 20, a locking wall 23 and a thin wall 32 overlap each other in the up-down direction, thereby forming a stacked wall 39 in which two walls are stacked on each other. The stacked wall 39 is formed on each of the upper and lower surface portions of the holding member 20. The two stacked walls 39 are spaced apart from each other in the up-down direction (a direction orthogonal to the direction in which the low-curvature part 16 is sandwiched between the pressure-receiving wall 22 and the thick wall 31). A locking wall 23 and a thin wall 32 that constitute a stacked wall 39 are located at positions where these walls do not face the harness insertion space 38. The locking holes 24, the long elastic locking piece 34L, and the short elastic locking piece 34S are located at positions where they do not face the harness insertion space 38.

The wire harness according to Embodiment 1 includes one harness body 10, one holding member 20, and one positioning member 30. The harness body 10 is elastically deformable, and includes the bent part 15 that is elastically bent, and a pair of low-curvature parts 16 having a smaller curvature than the bent part 15. The holding member 20 holds the bent part 15 in a bent state by bringing only the pair of low-curvature parts 16 of the harness body 10 into contact with the holding member 20. The positioning member 30 is disposed on the inner side of the holding member 20 so that the positioning member 30 is press-fitted between the pair of low-curvature parts 16. The positioning member 30 attached to the holding member 20 sandwiches the low-curvature parts 16 together with the holding member 20. Positional misalignment of the low-curvature parts 16 with respect to the holding member 20 can be suppressed by the frictional resistance between the low-curvature parts 16 and the holding member 20 and the frictional resistance between the low-curvature parts 16 and the positioning member 30.

Since the holding member 20 does not come into contact with the bent part 15, the load on the bent part 15 is not increased by the contact with the holding member 20. Since the positioning member 30 does not come into contact with the bent part 15 either, the load on the bent part 15 is not increased by the contact with the positioning member 30. Therefore, it is possible to hold the bent part 15 in a bent shape without increasing a load on the bent part 15. Because the low-curvature parts 16 are sandwiched between the holding member 20 and the positioning member 30, it is possible to prevent the bent part 15 (harness body 10) from being displaced relative to the holding member 20 in the axial direction.

The holding member 20 is made of a material having a higher hardness than the outer peripheral portions of the low-curvature parts 16. The frictional resistance caused by elastic deformation of the outer peripheral portions of the prevents positional misalignment between the low-curvature parts 16 low-curvature parts 16 and the holding member 20. Because the holding member 20 having a higher hardness than the low-curvature parts 16 are relatively hard to deform, it is possible to reliably prevent expansion and deformation of the pair of low-curvature parts 16. Because the positioning member 30 is also made of a material having a higher hardness than the outer peripheral portions of the low-curvature parts 16, the low-curvature parts 16 can be reliably sandwiched between the holding member 20 and the positioning member 30. This makes it possible to prevent the low-curvature parts 16 from being positionally misaligned with respect to the holding member 20 and the positioning member 30.

The holding member 20 has a ring shape that is continuous around the entire perimeter. The pair of low-curvature parts 16 are inserted into the accommodation space 21 of the holding member 20. Since the holding member 20 has a ring shape that is continuous around the entire perimeter, even when the pair of low-curvature parts 16 are about to expand due to elastic restoring force of the bent part 15, expansion and displacement of the pair of low-curvature parts 16 can be prevented. This allows the bent part 15 to be maintained at an expected curvature.

Each low-curvature part 16 is sandwiched in the width direction between a pressure-receiving wall 22 of the holding member 20 and a thick wall 31 of the positioning member 30. The maximum dimension of the positioning member 30 in the width direction is larger than a dimension obtained by subtracting the sum of the maximum outer dimensions of the low-curvature parts 16 in the width direction from the maximum dimension of the holding member 20 between the inner surfaces of the holding member 20 (accommodation space 21) in the width direction. Because the low-curvature parts 16 are compressed and deformed between the holding member 20 and the positioning member 30, positional misalignment of the low-curvature parts 16 is unlikely to occur.

Edges of the outer peripheral surface of the positioning member 30, the edges coming into sliding contact with the low-curvature parts 16 in the process of attaching the positioning member 30 to the holding member 20, are provided with interference mitigation portions 37 constituted by curved surfaces. When attaching the positioning member 30 to the holding member 20 while inserting the positioning member 30 between the pair of low-curvature parts 16, the interference mitigation portions 37 come into sliding contact with the low-curvature parts 16, thus preventing the low-curvature parts 16 from being scratched by the edges of the positioning member 30.

The positioning member 30 has the through space 33 extending in the same direction (front-rear direction) as the direction in which the low-curvature parts 16 are inserted into the holding member 20. By forming the through space 33, it is possible to reduce the weight of the positioning member 30 and a material cost. Because a finger can be inserted into the through space 33, the positioning member 30 can be easily grasped by a hand of an operator.

The positioning member 30 has the long elastic locking pieces 34L and the short elastic locking pieces 34S that are elastically displaceable. The holding member 20 has the locking holes 24 in which the long elastic locking pieces 34L or the short elastic locking pieces 34S are locked. By locking the long elastic locking pieces 34L in the locking holes 24 and locking the short elastic locking pieces 34S in the locking holes 24, the positioning member 30 can be kept attached to the holding member 20.

In the process of attaching the positioning member 30 to the holding member 20, the long elastic locking piece 34L and the short elastic locking piece 34S are elastically deformed to enter the through space 33. The through space 33 functions as a warp allowing space for elastically deforming the elastic locking pieces 34L and 34S. The shape of the positioning member 30 can be simplified, compared to a case where the positioning member 30 is provided with the warp allowing space for the elastic locking pieces 34L and 34S, separately from the through space 33.

The positioning member 30 has a pair of thin walls 32 provided with the long elastic locking pieces 34L and the short elastic locking pieces 34S, and a pair of thick walls 31 that are thicker than the thin walls 32. The pair of low-curvature parts 16 are sandwiched in a state in which the low-curvature parts 16 are individually pressed between the pair of thick walls 31 and the pair of pressure-receiving walls 22 of the holding member 20. The long elastic locking pieces 34L and the short elastic locking pieces 34S are formed on the thin walls 32, and thus are relatively likely to be elastically displaced. It is possible to reduce the frictional resistance between the long elastic locking pieces 34L and the holding member 20 and the frictional resistance between the short elastic locking pieces 34S and the holding member 20 and improve assembly workability in the process of attaching the positioning member 30 to the holding member 20. Because the thick walls 31, which are thicker than the thin walls 32, are less likely to be elastically deformed even when subjected to a reaction force from the low-curvature parts 16, the low-curvature parts 16 can be reliably positioned between the holding member 20 and the thick walls 31.

The holding member 20 includes the locking walls 23 having the locking holes 24. The locking walls 23 has a larger thickness than the thin walls 32. The locking walls 23 are walls that are thicker than the thin walls 32, and thus the depth of the locking holes 24 (the thickness of the locking walls 23) is also relatively large. This makes it possible to ensure large locking allowances between the locking holes 24 and the elastic locking pieces 34L and 34S (locking protrusions 36L and 36S) in the thickness direction of the locking walls 23.

A wall (locking wall 23) of the holding member 20 and a wall (thin wall 32) of the positioning member 30 are overlapped in a direction (up-down direction) intersecting the direction in which the low-curvature parts 16 are sandwiched therebetween to form each stacked wall 39. The stacked walls 39 are provided with the long elastic locking pieces 34L, the short elastic locking pieces 34S, and the locking holes 24. Each stacked wall 39 is constituted by walls (locking wall 23 and thin wall 32) overlapping each other in the direction intersecting the direction in which the low-curvature part 16 is sandwiched, and thus the stacked wall 39 does not face the low-curvature part 16. Because the long elastic locking piece 34L, the short elastic locking piece 34S, and the locking holes 24 are disposed at positions where they do not face the low-curvature part 16, interference between the long elastic locking piece 34L, the short elastic locking piece 34S, and the low-curvature part 16 can be prevented.

Two stacked walls 39 are disposed at two positions spaced apart from each other in the direction (up-down direction) orthogonal to a direction in which the pair of low-curvature parts 16 are arranged. The two stacked walls 39 are provided with the long elastic locking pieces 34L, the short elastic locking pieces 34S, and the locking holes 24. Because a long elastic locking piece 34L is locked in a locking hole 24 and a short elastic locking piece 34S is locked in a locking hole 24 at two positions spaced apart from each other, the positioning member 30 can be reliably held by the holding member 20.

In one locking wall 23, a pair of locking holes 24 are arranged obliquely with respect to the direction (front-rear direction) in which the low-curvature parts 16 are inserted into the holding member 20. A longer separation distance between the pair of locking holes 24 can be ensured in the limited space defined by the stacked walls 39, compared to a case where the pair of locking holes 24 are arranged parallel to the direction in which the low-curvature parts 16 are inserted into the holding member 20, and a case where the locking holes 24 are arranged in a direction orthogonal to the insertion direction of the low-curvature parts 16. This makes it possible to suppress relative rotation between the locking wall 23 of the holding member 20 that constitutes a stacked wall 39 and a thin wall 32 of the positioning member 30 that constitutes the stacked wall 39 when a rotational force, which is centered on a virtual axis V (see FIGS. 2 to 4) extending in the up-down direction and parallel to the overlapping direction of the stacked walls 39, is applied to the locking wall 23 and the thin wall 32.

The long elastic locking piece 34L and the short elastic locking piece 34S are arranged. By arranging two elastic locking pieces 34L and 34S having different lengths side-by-side, it is possible to reduce assembly resistance when attaching the positioning member 30 to the holding member 20 and realize a function to prevent the positioning member 30 from coming loose.

### OTHER EMBODIMENTS

The present disclosure is not limited to the embodiment described using the description and drawings, and is indicated by the claims. The present disclosure is intended to include all modifications within the meaning and scope equivalent to the claims, and embodiments below.

A low-curvature part sandwiched between the holding member and the positioning member is not limited to a part whose axis extends in a straight line, and may be a part whose axis is slightly curved.

The shape of the holding member is not limited to rectangular, but may be square, trapezoidal, circular, elliptical, oval, or the like.

The shape of the holding member is not limited to a ring shape that is continuous around the entire perimeter, and may be an “S-shape” or a “C-shape”.

The holding member is no limited to a single component, and may be an assembly of multiple components.

The holding member may be a metallic ring embedded and integrated inside a ring-shaped member made of hard rubber.

The holding member may be constituted only by hard rubber.

The positioning member may be made of hard rubber.

A configuration may be adopted in which a positioning functional part constituted by a groove to which a low-curvature part is fitted, an elastic piece that elastically sandwiches a low-curvature part, and the like may be formed as a single body with the holding member without providing a positioning member separately from the holding member, and positional misalignment of the low-curvature part with respect to the holding member is prevented by the positioning functional part.

The elastic locking piece may be formed only on the holding member, the locking hole may be formed only in the positioning member, or the elastic locking piece and the locking hole may be formed in both the holding member and the positioning member.

The pair of locking holes may be arranged parallel to the direction in which the low-curvature parts are inserted into the holding member, or may be arranged side-by-side in a direction orthogonal to the insertion direction of the low-curvature parts.

The pair of elastic locking pieces arranged in parallel to each other may have the same length.

The elastic locking piece and the locking hole may be formed only in one of the two stacked walls disposed at two upper and lower positions.

The positioning member may be a solid component having no through space.

The four walls that constitute the positioning member may have the same thickness.

The thickness of the locking wall of the holding member may be the same as or smaller than the thickness of the thin wall of the positioning member.

The thickness of the pressure-receiving wall of the holding member may be the same as or larger than the thickness of the thick wall of the positioning member.

The thickness of the pressure-receiving wall of the holding member and the thickness of the locking wall may differ from each other.

1. A wire harness comprising:
an elastically deformable harness body that includes a bend that is elastically bent and a pair of low-curvature sides having a smaller curvature than the bend; and
a holding body that holds the bend in a bent state by bringing only the pair of low-curvature sides of the harness body into contact with the holding body.

2. The wire harness according to claim 1,
wherein the holding body is made of a material having a higher hardness than outer peripheral portions of the low-curvature sides.

3. The wire harness according to claim 1, wherein:
the holding body has a ring shape that is continuous around an entire perimeter, and
the pair of low-curvature sides are inserted into the holding body.

4. The wire harness according to claim 3, comprising
a positioning body that is disposed on an inner side of the holding body and sandwiches the low-curvature sides together with the holding body.

5. The wire harness according to claim 4,
wherein the positioning body is attached to the holding body so that the positioning body is press-fitted between the pair of low-curvature sides.

6. The wire harness according to claim 4,
wherein both the holding body and the positioning body are made of a material having a higher hardness than outer peripheral portions of the low-curvature sides.

7. The wire harness according to claim 6, wherein:
when a direction in which the low-curvature sides are sandwiched between the holding body and the positioning body is defined as a width direction,
a maximum dimension of the positioning body in the width direction is larger than a dimension obtained by subtracting a sum of maximum outer dimensions of the low-curvature sides in the width direction from a maximum dimension of the holding body between inner surfaces of the holding body in the width direction.

8. The wire harness according to claim 6,
wherein edges of an outer peripheral surface of the positioning body, the edges coming into sliding contact with the low-curvature sides in a process of attaching the positioning body to the holding body, are provided with interference mitigation portions each constituted by a curved surface or a tapered surface.

9. The wire harness according to claim 4,
wherein the positioning body has a through space extending in a same direction as a direction in which the low-curvature sides are inserted into the holding body.

10. The wire harness according to claim 4, wherein:
one of the holding body and the positioning body has an elastic locking piece that is elastically displaceable, and
the other of the holding body and the positioning body has a locking hole in which the elastic locking piece is locked.

11. The wire harness according to claim 10, wherein:
the positioning body has a through space extending in a same direction as a direction in which the low-curvature sides are inserted into the holding body,
the elastic locking piece is formed on the positioning body, and
the elastic locking piece is elastically deformed to enter the through space in a process of attaching the positioning body to the holding body.

12. The wire harness according to claim 11,
wherein the positioning body includes a pair of thin walls on each of which the elastic locking piece is formed, and a pair of thick walls that are thicker than the thin walls and press the pair of low-curvature sides and sandwich the pair of low-curvature sides together with the holding body.

13. The wire harness according to claim 12, wherein:
the holding body includes a locking wall having the locking hole, and
the locking wall has a larger thickness than the thin walls.

14. The wire harness according to claim 10, wherein:
a wall of the holding body and a wall of the positioning body are overlapped in a direction intersecting a direction in which the low-curvature sides are sandwiched therebetween to form a stacked wall, and
the stacked wall is provided with both the elastic locking piece and the locking hole.

15. The wire harness according to claim 14, wherein:
the stacked wall is two stacked walls,
the two stacked walls are disposed at two positions spaced apart from each other in a direction orthogonal to a direction in which the pair of low-curvature sides are arranged, and
the two stacked walls are each provided with the elastic locking piece and the locking hole.

16. The wire harness according to claim 14, wherein:
the locking hole is a pair of locking holes, and
the pair of locking holes are arranged obliquely with respect to a direction in which the low-curvature sides are inserted into the holding body.

17. The wire harness according to claim 10, wherein:
the elastic locking piece is a plurality of elastic locking pieces including a long elastic locking piece and a short elastic locking piece, and
the long elastic locking piece and the short elastic locking piece are arranged in parallel to each other.
